(19) United States
(12) Patent Application Publication
(10) Pub. No.: US 2004/0246756 A1
(43) Pub. Date: Dec. 9, 2004

(54) Arcp converter and a method for control thereof

(76) Inventors: Bo Bijlenga, Amal (SE); Nicklas Johansson, Uppsala (SE); Tomas Jonsson, Vasaras (SE); Peter Lundberg, Vasteras (SE); Staffan Norrga, Stockholm (SE)

Correspondence Address: BURNS DOANE SWECKER & MATHIS L L P, POST OFFICE BOX 1404, ALEXANDRIA, VA, 22313-1404, US

(21) Appl. No.: 10/489,665

(22) PCT Filed: Sep. 16, 2002
(86) PCT No.: PCT/SE02/01652

(30) Foreign Application Priority Data
Sep. 21, 2001 (SE) 0103140-0

(51) Int. Cl. H02M 7/5387

(52) U.S. Cl. 363/132

(57) ABSTRACT

The invention relates to a converter provided with a resonant circuit, in which converter the resonant circuit comprises means for detecting a zero current condition in the auxiliary valve. The means is adapted to send to the control device of the converter signals indicating a prevailing zero current condition in the auxiliary valve, and the control device is adapted to allow a turn-off of a semiconductor component of turn-off type of the auxiliary valve only after the receipt by the control device of a signal indicating a prevailing zero current condition in the auxiliary valve. The invention also relates to a method for controlling such a converter.

### FIELD OF THE INVENTION AND PRIOR ART

The present invention relates to a converter according to the preamble of claim 1 and a method for controlling such a converter.

The invention particularly relates to a VSC-converter. A VSC-converter for connection between a direct voltage network and an alternating voltage network is previously known e.g. from the thesis “PWM and control of two and three level high voltage source converters” by Anders Lindberg, Royal Institute of Technology, Stockholm, 1995, in which publication a plant for transmitting electric power through a direct voltage network for high-voltage direct current (HVDC), while utilizing such converters, is described. Before the creation of this thesis, plants for transmitting electric power between a direct voltage network and an alternating voltage network have been based upon the use of network commutated CSC (Current Source Converter)-converters in stations for power transmission. However, in this thesis a totally new concept is described, which is based on instead using VSC (Voltage Source Converter)-converters for forced commutation for transmitting electric power between a direct voltage network being voltage stiff therethrough, in the case in question for high-voltage direct current, and alternating voltage networks connected thereto, which offers several considerable advantages as compared to the use of network commutated CSC-converters in HVDC, among which it may be mentioned that the consumption of active and reactive power may be controlled independently of each other and that there is no risk of commutation faults in the converters and thereby no risk of commutation faults being transmitted between different HVDC-links, as may occur with network commutated CSC:s. Furthermore, it is possible to feed a weak alternating voltage network or a network without any generation of its own (a dead alternating voltage network). There are also further advantages.

The inventive converter may be included in a plant for transmitting electric power through a direct voltage network for high-voltage direct current (HVDC), in order to e.g. transmit the electric power from the direct voltage network to an alternating voltage network. In this case, the converter has its direct voltage side connected to the direct voltage network and its alternating voltage side connected to the alternating voltage network. The inventive converter may however also be directly connected to a load, such as a high-voltage generator or motor, in which case the converter has either its direct voltage side or its alternating voltage side connected to the generator/motor. The invention is not limited to these applications; on the contrary, the converter may just as well be used for conversion in a SVC (Static Var Compensator) or a back-to-back-station. The voltages on the direct voltage side of the converter are with advantage high, 10-400 kV, preferably 130-400 kV. The inventive converter may also be included in other types of FACTS-devices (FACTS=Flexible Alternating Current Transmission) than the ones mentioned above.

In order to limit the turn-off losses in the semiconductor elements of turn-off type of the current valves of the converter, i.e. the losses in the semiconductor elements of turn-off type when these are turned off, it is previously known to arrange capacitive members in the form of so-called snubber capacitors connected in parallel across the respective semiconductor element of turn-off type. It is also known to provide the converter with a so-called resonant circuit for recharging said snubber capacitors in connection with commutation of the phase current. Hereby, it will also be possible to limit the turn-on losses in the semiconductor elements of turn-off type of the current valves, i.e. the losses in the semiconductor elements of turn-off type when these are turned on.

A type of converters provided with a resonant circuit that has been developed are the so-called ARCP-converters (ARCP=Auxiliary Resonant Commutation Pole), which comprise a resonant circuit adapted to achieve a recharge of the snubber capacitors of the current valves in connection with commutation of the phase current from a rectifying member of a current valve to a semiconductor element of turn-off type of another current valve so that said semiconductor element can be turned on at low voltage instead of high voltage, whereby the turn-on losses in the semiconductor element of the current valve is limited. The resonant circuit is also used when the phase current is commutated from a semiconductor element of turn-off type of a current valve to a rectifying member of another current valve, i.e. in connection with turn-off of a semiconductor element of the first-mentioned current valve, when the phase current is so low that the switching time for the voltage in the phase output otherwise would be unreasonably long.

### OBJECT OF THE INVENTION

The object of the present invention is to make possible a cost-effective design of the auxiliary valve of an ARCP-converter.

### SUMMARY OF THE INVENTION

According to the invention, said object in achieved by means of a converter according to claim 1 and a method according to claim 13.

The inventive solution implies that the semiconductor components of turn-off type of the auxiliary valve do not have to be turned off when they are carrying current, which in its turn entails that semiconductor components of cheaper and less space-requiring design can be used in the auxiliary valve as compared to the case that these semiconductor components had been required to withstand a turn-off while carrying current.

According to a preferred embodiment of the invention, a zero current condition in the auxiliary valve is detected by detection of a blocking voltage of the semiconductor components of the auxiliary valve, this blocking voltage preferably being detected with the aid of the control units that are adapted to execute turn-on and turn-off of the semiconductor components of turn-off type of the auxiliary valve guided by control signals received from the control device. Hereby, a zero current condition can be detected in a simple and effective manner with the use of the existing control equipment of the auxiliary valve, which makes possible a very cost-effective implementation of the inventive solution.

According to a further preferred embodiment of the invention, the control device is adapted to prevent that a semiconductor component of turn-off type of the auxiliary valve is in turned-on state at the same time as a semiconductor element of turn-off type with the same polarity is in turned-on state in any of the current valves. Hereby, it is prevented that a semiconductor component of turn-off type of the auxiliary valve and a semiconductor element of turn-off type of the current valve that is arranged with the same polarity, i.e. a semiconductor component and a semiconductor element that have the same current direction, are conducting a current simultaneously. This entails that the current that is flowing through the resonant circuit in connection with a commutation is limited as to its size, which in its turn entails a limitation of the strain on the semiconductor components of turn-off type of the auxiliary valve and a limitation of the losses in the resonant circuit.

According to a further preferred embodiment of the invention, the control device is adapted to allow a turn-on of a semiconductor component of turn-off type of the auxiliary valve only if it has received from the control unit belonging to a semiconductor element of turn-off type of a current valve with the same polarity a signal indicating that this semiconductor element of turn-off type is in turned-off state. Hereby, it is in a simple and secure manner prevented that a turn-on of a semiconductor component of turn-off type of the auxiliary valve results in that a semiconductor component of turn-off type of the auxiliary valve and a semiconductor element of turn-off type of a current valve having the same current direction are conducting a current simultaneously.

According to a further preferred embodiment of the invention, the control device is adapted to allow a turn-on of a semiconductor element of turn-off type of a current valve only if it has received from the control unit belonging to a semiconductor component of turn-off type of an auxiliary valve with the same polarity a signal indicating that this semiconductor component of turn-off type is in turned-off state. Hereby, it is in a simple and secure manner prevented that a turn-on of a semiconductor element of turn-off type of a current valve results in that a semiconductor component of turn-off type of the auxiliary valve and a semiconductor element of turn-off type of a current valve having the same current direction are conducting a current simultaneously.

According to a further preferred embodiment of the invention, the control device is adapted to allow a turn-on of a semiconductor component of turn-off type of the auxiliary valve only if it has received from the control unit(-s) of the auxiliary valve a signal indicating that the semiconductor components of turn-off type of the auxiliary valve with opposite polarity are in turned-off state. Hereby, it is prevented that semiconductor components of turn-off type with mutually opposite polarity are simultaneously in turned-on state in the auxiliary valve, whereby it is secured that a turn-off of a semiconductor component of the auxiliary valve always results in a turn-off of the auxiliary valve. This turn-off of the auxiliary valve is achieved in that the rectifying component that is arranged in anti-parallel with the semiconductor component that is being turned-off is blocking.

According to a further preferred embodiment of the invention, the control device is in connection with the effectuation of a turn-on of a semiconductor component of turn-off type of the auxiliary valve adapted to send a turn-on signal of time-delayed type to a control unit that is arranged to execute turn-on and turn-off of a semiconductor element of turn-off type of a current valve with opposite polarity, this control unit being adapted to turn on the semiconductor element of turn-off type after a predetermined time length has elapsed from the moment the control unit received said turn-on signal unless the control unit receives a turn-on signal of ordinary type from the control device before said predetermined time length has elapsed. Hereby, it is secured that the intended current valve will be turned on after the resonance current, i.e. the current flowing through the resonant circuit, has fulfilled its task to recharge the snubber capacitors of the current valves, even if an error, entailing that a scheduled turn-on signal of ordinary type will not be sent to the control unit of the current valve in question, would occur for instance in the control device. In this way, it is secured that the resonance current will be diverted from the resonant circuit to the intended current valve after the resonance phase, whereby an overloading of the semiconductor components of turn-off type of the auxiliary valve due to remaining resonance current in the resonant circuit after terminated resonance phase is avoided.

According to a further preferred embodiment of the invention, the control device is adapted to allow a turn-off of a semiconductor element of turn-off type of a current valve only if it has received from the control unit belonging to a semiconductor component of turn-off type of an auxiliary valve with opposite polarity a signal indicating that this semiconductor component of turn-off type is in turned-off state. Hereby, it is secured that the diversion of current from the resonant circuit to the intended current valve is completed before a new commutation is initiated, which helps to prevent an overloading of the semiconductor components of turn-off type of the auxiliary valve due to remaining current in the resonant circuit after terminated resonance phase.

Further preferred embodiments of the inventive converter and the inventive method will appear from the dependent claims and the subsequent description.

### BRIEF DESCRIPTION OF THE DRAWINGS

The invention will in the following be more closely described by means of embodiment examples, with reference to the appended drawings. It is shown in:

FIG. 1 a simplified circuit diagram illustrating a converter according to a first embodiment of the invention,

FIG. 2 a simplified circuit diagram illustrating a converter according to an alternative embodiment of the invention,

FIG. 3 a simplified block diagram illustrating a control system for effectuation of the inventive method.

### DETAILED DESCRIPTION OF PREFERRED EMBODIMENTS

A converter according to an embodiment of the invention is illustrated in FIG. 1. The converter is here a so-called VSC-converter. In FIG. 1, only the part of the converter that is connected to one phase of an alternating voltage phase line is shown, the number of phases normally being three, but this may also constitute the entire converter when this is connected to a single phase alternating voltage network. The shown part of the converter constitutes a so-called phase leg, and a converter adapted for instance to a three-phase alternating voltage network comprises three phase legs of the type shown.

VSC-converters are known in several designs. In all designs, a VSC-converter comprises a number of so-called current valves, each of which comprising a semiconductor element of turn-off type, such as an IGBT (Insulated Gate Bipolar Transistor) or a GTO (Gate Turn-Off Thyristor), and a rectifying member in the form of a diode, a so-called free wheeling diode, connected in anti-parallel therewith. Each semiconductor element of turn-off type is normally in high-voltage applications built up of several series connected, simultaneously controlled semiconductor components of turn-off type, such as several separate IGBT:s or GTO:s. In high-voltage applications a comparatively high number of such semiconductor components is required in order to hold the voltage to be held by each current valve in the blocking state. In the corresponding manner, each rectifying member is built up of several series connected rectifying components. The semiconductor components of turn-off type and the rectifying components are in the current valve arranged in several series connected circuits, each of which circuits comprising i.a. a semiconductor component of turn-off type and a rectifying component connected in anti-parallel therewith.

The phase leg of the converter illustrated in FIG. 1 has two current valves 2, 3 connected in series between the two poles 4, 5 of a direct voltage side of the converter. A direct voltage intermediate link 6 comprising two so-called intermediate link capacitors is provided between the two poles 4, 5. In the converter illustrated in FIG. 1 the intermediate link 6 comprises two series contacted intermediate link capacitors 7, 8. A midpoint 9 between these capacitors 7, 8 is here, as customary, connected to ground, so as to provide the potentials +U_{d}/2 and −U_{d}/2, respectively, at the respective pole, U_{d} being the voltage between the two poles 4, 5. The grounding point 9 may however be excluded, for instance in SVC-applications.

A midpoint 10 of the series connection between the two current valves 2 and 3, which constitutes the phase output of the converter, is connected to an alternating voltage phase line 11. In this manner, said series connection is divided into two equal parts with a current valve 2 and 3, respectively, in each such part. In the embodiment with three phase legs, the converter consequently comprises three phase outputs, which are connected to a respective alternating voltage phase line of a three-phase alternating voltage network. The phase outputs are normally connected to the alternating voltage network via electric equipment in the form of breakers, transformers etc.

In the embodiment shown in FIG. 1, the respective current valve 2, 3 comprises a semiconductor element 13a, 13b of turn-off type, such as an IGBT, an IGCT, a MOSFET, a JFET, a MCT or a GTO, and a rectifying member 14 in the form of a diode, a so-called freewheeling diode, connected in anti-parallel therewith. Each of the current valves 2, 3 is provided with a capacitive member 15, here denominated snubber capacitor, connected in parallel with the semiconductor element 13a, 13b of turn-off type included in the current valve.

As indicated above, each semiconductor element 13a, 13b of turn-off type may be built up of several series connected semiconductor components of turn-off type, in which case each rectifying member is built up of several series connected rectifying components. These semiconductor components of turn-off type and rectifying components are in the respective current valve 2, 3 arranged in several series connected circuits, as will be more closely described with reference to FIG. 2.

When a semiconductor element 13a, 13b of a current valve is turned off, the snubber capacitor 15 that is connected across this semiconductor element will be charged. If the snubber capacitor 15 keeps this charge when the semiconductor element subsequently is turned on, turn-on losses will ensue in the semiconductor element. In order to eliminate or at least reduce these turn-on losses, and make possible the use of high switching frequencies, the snubber capacitors 15 are included in a resonant circuit 16. Hereby, it will be possible to accomplish a discharge of the snubber capacitors 15 of a current valve when the semiconductor element 13a, 13b of the current valve is to be turned on, so that the voltage across the semiconductor element is equal to or close to zero when it is turned on, whereby the turn-on losses are limited.

It is also possible to include a capacitor arranged between the phase output 10 and the midpoint 9 of the direct voltage intermediate link in the resonant circuit 16.

The converters illustrated in FIG. 1 and 2 are of the type denominated ARCP-converter. The resonant circuit 16 is here of so-called quasi-resonant type, which implies that the resonance only is initiated when the current is to be commutated between two current valves, i.e. when the voltage on the phase output of the converter is to be changed-over.

In the embodiment shown in FIG. 1, the resonant circuit 16 comprises a series connection of an inductor 17 and an auxiliary valve 18 arranged between the phase output 10 and the mid-point 9 of said series connection of intermediate link capacitors 7, 8. The auxiliary valve 18 here comprises a set of two series connected auxiliary valve circuits 19, each of which comprising a semiconductor component 20a, 20b of turn-off type, such as an IGBT, an IGCT, a MOSFET, a JFET, a MCT or a GTO, and a rectifying component 21a, 21b in the form of a diode connected in anti-parallel therewith. The semiconductor components 20a, 20b of turn-off type of the two auxiliary valve circuits 19 are arranged in opposite polarity in relation to each other. This auxiliary valve 18 constitutes a bi-directional valve that can be made to conduct in one or the other direction.

In this description and the subsequent claims, the expression auxiliary valve refers to a current valve included in the resonart circuit 16 of the converter.

The auxiliary valve 18 may also comprise several series connected sets of auxiliary valve circuits if considered appropriate, as illustrated in FIG. 2. In the embodiment illustrated in FIG. 2, the resonant circuit comprises an auxiliary valve 18 comprising several series connected sets 22 of auxiliary valve circuits, each set comprises two series connected auxiliary valve circuits 19 of the type described above. Only two series connected sets 22 of auxiliary valve circuits of the auxiliary valve 18 are shown in FIG. 2, but the number of such sets may be considerably larger than that. The number of sets of auxiliary valve circuits in the auxiliary valve 18 may be optimised independently of the number of series connected circuits 12 in the current valves 2, 3, and depends i.a. on the voltage the auxiliary valve is to be able to hold in the blocking state and the characteristics of the individual semiconductor components 20a, 20b that are being used. Generally, it can be observed that the auxiliary valve 18 in the blocking state only has to hold half the pole voltage, i.e. U_{d}/2, in contrast to the current valves 2, 3, which each has to be dimensioned so as to be able to hold the entire pole voltage U_{d} in the blocking state.

In the embodiment shown in FIG. 2, the respective current valve 2, 3 comprises, in accordance with the above indicated, several series connected circuits 12, each of which circuits comprising a semiconductor component 13a′, 13b′, and a rectifying component 14′ in the form of a diode connected in anti-parallel therewith. In FIG. 2, only two series connected circuits 12 of the type described above is shown in the respective current valve 2, 3, but the number of series connected circuits 12 may of course be larger. Depending i.a. on the voltage for which the converter is designed, the number of said series connected circuits 12 in the respective current valve 2, 3 may extend from two up to several hundred.

Each of the series connected circuits 12 of the respective current valve 2, 3 is provided with a capacitor 15′, here denominated snubber capacitor, connected in parallel with the semiconductor component 13a′, 13b′ of turn-off type included in the circuit. The capacitance of the respective snubber capacitor 15′ must be so high that a good voltage distribution between the semiconductor components 13a′, 13b′ of turn-off type included in the respective current valve is made possible in connection with a turn-off of the semiconductor components of turn-off type of a current valve. The choice of capacitance of the snubber capacitors 15′ is adapted from case to case and depends i.a. on the current-handling capacity of the semiconductor components 13a′, 13b′ of turn-off type and the rectifying components 14′.

Each set 22 of auxiliary valve circuits 19 in the auxiliary valve 18 is suitably, as illustrated in FIG. 2, provided with its own control unit 23, which is adapted to control the turn-on and turn-off of the semiconductor components 20a, 20b of turn-off type included in the set, all control units 23 of the auxiliary valve being connected to a common control device 24, which is adapted to send control signals to all these control units 23. Hereby, a simultaneous control of all the auxiliary valve circuits 19 of the auxiliary valve is secured.

It is further preferred that each of the semiconductor components 13a′, 13b′ of turn-off type included in the current valves 2, 3 of the converter, as illustrated in FIG. 2, is provided with its own control unit 25, which is adapted to control the turn-on and turn-off of the semiconductor components 13a′, 13b′, all control units 25 of the current valves being connected to a common control device 24, which is adapted to send control signals to all the control units 25 included in a current valve 2, 3. Hereby, a simultaneous control of all the semiconductor components 13a, 13b of a current valve is secured. The control units 23 of the auxiliary valve and the control units 25 of the current valves are here connected to one and the same control device 24. The control units 23, 25 are preferably adapted, when they receive a turn-on signal or a turn-off signal from the control device 24, to send back a signal to the control device 24 as a confirmation that they have received said turn-on signal/turn-off signal. The confirmation signals received by the control device 24 can be used in order to indicate whether a specific semiconductor component of turn-off type of the auxiliary valve or a specific semiconductor element of turn-off type of a current valve is in turned-off or turned-on state.

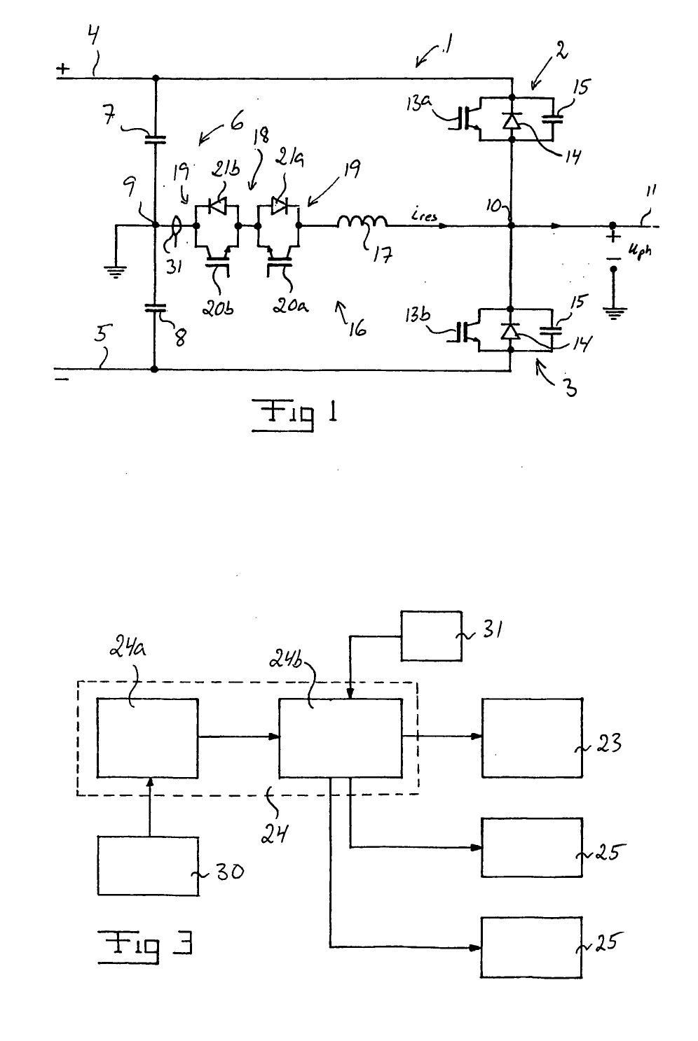

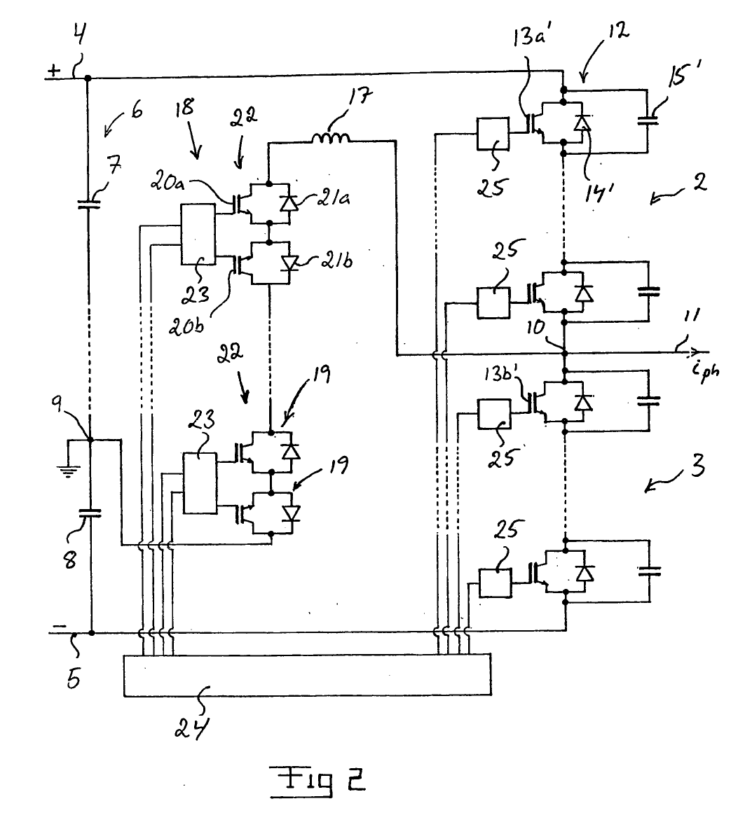

The inventive converter is preferably controlled with PWM-technique (PWM=Pulse Width Modulation), the control device 24 being supplied with signals representing the desired commutation instants from a modulator 30, schematically indicated in FIG. 3.

The inventive converter is provided with means for detecting a zero current condition in the auxiliary valve 18, schematically indicated at 31 in FIG. 3, which means is adapted to transmit detection signals to the control device 24.

In this description and the subsequent claims, the expression “zero current condition in the auxiliary valve” means that the current strength of the current flowing through the auxiliary valve is essentially zero. Per definition, a zero current condition in the auxiliary valve is in this description and the subsequent claims considered to arise in the moment when the resonance current has decreased so low that the rectifying component, or whenever applicable the rectifying components, of the auxiliary valve that has been conducting the resonance current in its forward direction assumes its blocking state and thereby ceases to conduct current in its forward direction.

Said means 31 may for instance comprise a measuring member, schematically indicated in FIG. 1, for measuring the strength of the current through the resonance circuit 16. When the current strength measured by the measuring member 31 is lower than a certain predetermined level, this will indicate that the strength of the current through the resonant circuit is essentially zero, i.e. that there is a zero current condition in the auxiliary valve 18.

According to a preferred embodiment of the invention, said means 31 comprises one or several members for detecting a blocking voltage of the rectifying components 21a, 21b of the auxiliary valve. When the strength of the resonance current has decreased to a sufficiently low value, essentially corresponding to zero current, a blocking voltage will namely ensue across the rectifying component or rectifying components 21a, 21b that has/have been current carrying in the auxiliary valve during the resonance phase. The blocking voltage will ensue across a rectifying component when it assumes its blocking state. By detecting that this blocking voltage ensues at the rectifying components in question, it will consequently be possible to establish that the strength of the current through the resonant circuit 16 has decreased to essentially zero, i.e. that there is a zero current condition in the auxiliary valve 18. The members for detecting a blocking voltage of the rectifying components 21a, 21b of the auxiliary valve suitably consist of the control units 23 of the auxiliary valve. In this case, it will namely be possible to register a voltage in the control unit 23 of a semiconductor component of turn-off type when a blocking voltage ensues across the rectifying component 21a, 21b that is connected in parallel with the semiconductor component 20a, 20b of turn-off type.

According to the invention, the control device 24 is adapted to allow a turn-off of a semiconductor component 20a, 20b of turn-off type of the auxiliary valve 18 only after the control device 24 has received from said means 31 a signal indicating a prevailing zero current condition in the auxiliary valve. Hereby, the semi-conductor components 20a, 20b of turn-off type of the auxiliary valve do not have to be dimensioned to be able to turn-off when they are carrying any actual current, i.e. they can be designed for a maximum allowed turn-off current essentially corresponding to zero current. The semiconductor components 20a, 20b of turn-off type of the auxiliary valve are suitably dimensioned for a maximum allowed turn-off current, a so-called SSOA-level (SSOA=Switching Safe Operating Area), of about 10% of the nominal phase current.

According to a preferred embodiment of the invention, the control device 24 is adapted to effectuate a turn-off of a semiconductor component 20a, 20b of turn-off type of the auxiliary valve with a time delay after the moment the control device 24 has received from said means 31 a signal indicating a prevailing zero current condition in the auxiliary valve 18. This time delay is so chosen that the recombination process of the semiconductor component 20a, 20b of turn-off type that is intended to be turned of will have time to be completed in the time interval from the moment a zero current condition is detected to the moment the semiconductor component 20a, 20b is turned-off. In a semiconductor component of turn-off type in the form of for instance an IGBT, an inner plasma is namely remaining after a current has been flowing through the semiconductor component, which results in that a reverse recovery current, which causes increased losses, is obtained in the semiconductor component if this is subjected to a forward voltage before the recombination process of the semiconductor component has had time to be completed. The above-mentioned time delay will secure that such a reverse recovery current is avoided.

After a blocking voltage has ensued across a rectifying component 21a, 21b that has been current carrying during the resonance phase, the snubber capacitor, not shown, that normally is connected in parallel with the rectifying component will rapidly be charged by the energy stored in the inductor 17. The parallel connected semiconductor component 20a, 20b of turn-off type will then enter a so-called clamping phase and a momentary voltage rise will ensue across this semiconductor component of turn-off type. After this clamping phase, the parallel connected snubber capacitor will be discharged and the voltage across the semiconductor component of turn-off type will resume its normal value. If the semiconductor component 20b, 20a of turn-off type that is intended to be turned off is turned off before the voltage across the previously mentioned semiconductor component 20a, 20b has resumed its normal value, an undesired increase of the final voltage of the snubber capacitor of said rectifying component 21a, 21b will ensue. In order to avoid this, the control device should be adapted not to allow a turn-off of a semiconductor component 20b, 20a of turn-off type that has been carrying a current until the voltage across a semiconductor component 20a, 20b of turn-off connected in anti-parallel therewith has resumed the normal value. This is suitably carried out in that the control device 24 keeps a semiconductor component of turn-off type that has been carrying a current in the turned-on state during the remaining time length of the PWM-period.

In case a semiconductor component 20a, 20b of turn-off type of the auxiliary valve 18 is current carrying at the same time as a semiconductor element 13a, 13b of turn-off type with the same polarity is current carrying in a current valve, there is a risk that the current through the semiconductor component 20a, 20b of turn-off type of the auxiliary valve will increase to such a high value that the semiconductor component 20a, 20b of turn-off type of the auxiliary valve is overloaded and thereby destroyed. The expression “same polarity” here means that a semiconductor component of turn-off type of the auxiliary valve and a semiconductor element of turn-off type of the current valve connected in series therewith are so arranged that they conduct a current in the same direction. In the embodiment according to FIG. 1, the semiconductor element 13a of turn-off type consequently has the same polarity as the semiconductor component 20a of turn-off type and the semiconductor element 13b of turn-off type the same polarity as the semiconductor component 20b of turn-off type.

In order to prevent said overloading, the control device 24 is according to a preferred embodiment of the invention adapted to prevent that a semiconductor component 20a, 20b of turn-off type of the auxiliary valve 18 is in turned-on state at the same time as a semiconductor element 13a, 13b of turn-off type with the same polarity is in turned-on state in any of the current valves 2, 3. According to this embodiment, the control device 24 is consequently adapted to allow a turn-on of a semiconductor component 20a, 20b of turn-off type of the auxiliary valve only if it has received from the control unit 25 belonging to a semiconductor element 13a, 13b of turn-off type with the same polarity a signal indicating that this semiconductor element 13a, 13b of turn-off type is in turned-off state. Furthermore, the control device 24 should be adapted to allow a turn-on of a semiconductor element 13a, 13b of turn-off type of a current valve 2, 3 only if it has received from the control unit 23 belonging to a semiconductor component 20a, 20b of turn-off type with the same polarity a signal indicating that this semiconductor component 20a, 20b of turn-off type is in turned-off state. The establishment that a semiconductor element 13a, 13b of turn-off type and a semi-conductor component 20a, 20b of turn-off type, respectively, is in turned-off state is suitably based on the signal sent to the control device 24 from the control unit 23, 25 of the respective element/component that confirms that a turn-off signal, i.e. a turn-off order, has been received by the control unit in question. When such a confirmation signal has been received by the control device 24, or possibly a short moment after the receipt, the semiconductor component in question or the semiconductor element in question in considered to be turned off.

In order to further secure that an overloading of the above indicated type will not occur, the control device 24 is suitably adapted to prevent that semiconductor components 20a, 20b of turn-off type with mutually opposite polarity are simultaneously in turned-on state in the auxiliary valve 18. In order to secure this, the control device 24 is adapted to allow a turn-on of a semiconductor component 20a, 20b of turn-off type of the auxiliary valve only if it has received from the control unit(-s) 23 of the auxiliary valve a signal indicating that the semiconductor component(-s) 20b, 20a of turn-off type of the auxiliary valve with opposite polarity is in turned-off state. Also here, the establishment that a semiconductor component 20a, 20b of turn-off type is in turned-off state is suitably based on the signal sent to the control device 24 from the control unit 23 of the respective component that confirms that a turn-off signal, i.e. a turn-off order, has been received by the control unit in question. When such a confirmation signal has been received by the control device 24 or possibly a short moment after the receipt, the semiconductor component in question is considered to be turned off.

From the point of view of costs, it is advantageous to use semiconductor components of turn-off type in the auxiliary valve 18 dimensioned to withstand only the brief current pulses that occur in the resonant circuit during a normal commutation process. In order to prevent an overloading and destruction of such semiconductor components dimensioned with low capacity, the control device 24 should be adapted to secure that the current n an auxiliary valve 18 is always conducted back to a current valve 2, 3 after the termination of a commutation process, i.e. prevent remaining current in the resonant circuit after a terminated resonance phase. Hereby, it is also secured that a turn-off of the semiconductor components 20a, 20b of turn-off type of the auxiliary valve can take place after a terminated resonance phase in connection with the above-described use of semiconductor components 20a, 20b dimensioned for a very low maximum turn-off current.

One way of preventing remaining current in the resonant circuit after a terminated resonance phase is based on that the control device 24, in connection with the effectuation of a turn-on of a semiconductor component 20a, 20b of turn-off type of the auxiliary valve 18, is adapted to send a turn-on signal of time-delayed type to the control unit 25 of a semiconductor element 13b, 13a of turn-off type with the opposite polarity. This control unit 25 is then adapted to turn on the associated semiconductor element 13b, 13a of turn-off type after a predetermined time length has elapsed from the moment the control unit 25 received said turn-on signal of time-delayed type unless the control unit 25 receives a turn-on signal of ordinary type from the control device 24 before the predetermined time length has elapsed. Consequently, the expression “turn-on signal of time-delayed type” refers to a turn-on signal that will make the control unit 25 in question execute a turn-on of the associated semiconductor element 13a, 13b with a predetermined time-delay when it receives the turn-on signal. This time-delay is so chosen that a normal commutation process has time to be completed before the predetermined time length has elapsed. The expression “turn-on signal of ordinary type” refers to a turn-on signal that will make the control unit 25 in question execute a turn-on of the associated semiconductor element 13a, 13b immediately when it receives the turn-on signal. Said turn-on signal of time-delayed type will consequently secure that the semiconductor element 13a, 13b of turn-off type of the intended current valve 2, 3 will be turned on after the completion of the commutation process even if an error would ensue for instance in the control device 24 during a commutation process, which in its turn secures that the current will be diverted from the resonant circuit in the intended manner.

In order to further secure that remaining current in the resonant circuit after a terminated resonance phase is avoided, the control device 24 is suitably adapted to allow a turn-off of a semiconductor element 13a, 13b of turn-off type of a current valve only if it has received from the control unit belonging to a semiconductor component 20b, 20a of turn-off type with opposite polarity a signal indicating that this semiconductor component 20b, 20a of turn-off type is in turned-off state. Hereby, it is secured that the diversion of the current from the resonant circuit to the intended current valve is completed before a new commutation is initiated.

The expression “opposite polarity” here means that a semiconductor component of turn-off type of the auxiliary valve and a semiconductor element of turn-off type of the current valve connected in series therewith are so arranged that they are conducting current in opposite directions. In the embodiment according to FIG. 1, the semiconductor element 13a of turn-off type consequently has the opposite polarity in relation to the semiconductor component 20b of turn-off type and the semiconductor element 13b of turn-off type the opposite polarity in relation to the semiconductor component 20a of turn-off type.

As previously indicated, the auxiliary valve 18 of the inventive converter is intended to comprise semiconductor components of turn-off type dimensioned for a comparatively low maximum allowed turn-off current, in the following denominated SSOA-level. The semiconductor components of turn-off type of the auxiliary valve are further dimensioned to be capable of conducting a current, in the following denominated on-state current, of a certain maximum allowed strength without running the risk of being destroyed. This maximum allowed on-state current may for instance lie on about 6 kA. The resonant circuit is suitably provided with a measuring member 31 for measuring the strength of the current flowing in the resonant circuit so as to make it possible to control whether the current strength of the resonant circuit is above or below the SSOA-level and above or below the value for the maximum allowed on-state current. This measuring member 31 transmits measuring signals to the control device 24, which is adapted to evaluate the measuring signals in order to establish whether or not there is a risk of overloading the semiconductor components of turn-off type of the auxiliary valve. The control device 24 should further be adapted to carry out predetermined protective measures in case of an established risk of overloading.

In the following, different protective measures for preventing a destruction of the semiconductor components 20a, 20b of turn-off type of the auxiliary valve in case of an occurring and detected error situation will be described.

A first error situation implies that the value of the maximum allowed on-state current has been exceeded when the auxiliary valve 18 and a current valve 2, 3 are simultaneously conducting a current. In this case, the following steps are carried out:

1) First, a turn-off signal is sent from the control device 24 to the current valve 2, 3 that is presently feeding current to the auxiliary valve 18.

2) When the control device 24 has received a turn-off confirmation from said current feeding current valve 2, 3, a turn-on signal is sent from the control device 24 to the opposite current valve 3, 2 in order to divert the current from the auxiliary valve 18 via this current valve 3, 2. In order to minimize the risks of a short-circuit condition in the current valves, i.e. minimize the risks of both current valves 2, 3 conducting a current simultaneously, the control device 24 should be adapted to send said turn-on signal to the current valve in question only on condition that at least one of the current valves is in the blocking state, which is detected with the aid of signals from the control units 25 of the current valves, and that the control device 24 has received a turn-off confirmation from the control units 25 of both current valves.

3) When a blocking voltage has been detected in the rectifying component or components 21a, 21b of the auxiliary valve that was/were current carrying when the error situation was registered, or when it has been established that the strength of the on-state current has decreased below the SSOA-level for the semiconductor components of turn-off type of the auxiliary valve, a turn-off signal is sent from the control device 24 to the auxiliary valve. Said turn-off signal s preferably sent after a time delay of the type previously described, which secures that the recombination process of the semiconductor component or components 20a, 20b of turn-off type that is/are intended to be turned-off will have time to be completed before the turn-off is effectuated.

4) When the control device 24 has received a turn-off confirmation from the auxiliary valve 18, a turn-off signal is finally sent from the control device 24 to all the current valves 2, 3. These turn-off signals are preferably sent after a time delay that secures that the recombination process of the semiconductor elements 13a, 13b of turn-off type of the current valves will have time to be completed before the turn-off is effectuated.

In case a remaining current in the resonant circuit 16 is registered after the completion of the resonance phase, measures corresponding to those indicated under steps 1 to 4 above will be effectuated.

According to a previously described preferred embodiment of the invention, the control device 24 is, in connection with the effectuation of a turn-on of a semiconductor component 20a, 20b of turn-off type of the auxiliary valve 18, adapted to send a turn-on signal of time-delayed type to the control unit 25 of a semiconductor element 13b, 13a of turn-off type with opposite polarity. In this case, the control device 24 is suitably adapted to effectuate protective measures in accordance with the above described steps 1-4 in case the auxiliary valve 18 is still current carrying after a predetermined time length has elapsed from the moment said turn-on signal of time-delayed type was sent from the control device 24, said predetermined time length of course being longer than the time delay of said turn-on signal of time-delayed type.

As schematically illustrated in FIG. 3, the control device 24 is suitably divided into two separate units, here denominated with 24a and 24b. A first unit 24a constitutes a central processor unit adapted to calculate, guided by signals from the PWM-modulator 30, moments and sequence for the turn-on and turn-off of the semiconductor components 20a, 20b of turn-off type of the auxiliary valve and the semiconductor elements 13a, 13b of turn-off type of the current valves. A second unit 24b is responsible for sending turn-on and turn-off signals to the intended control units 23, 25 of the auxiliary valve or the current valves at the correct moments guided by the moments and sequence established by the first unit 24a. The second unit 24b is suitably responsible for the above-mentioned control method for avoiding an overloading of the semiconductor components 20a, 20b of turn-off type of the auxiliary valve so that the control can be carried out as rapidly as possible and with as few signal processing steps as possible. Consequently, said second unit 24b is suitably responsible for the evaluation of the measuring signals from the measuring member 31 and the initiation of required protective measures.

When an error situation implying a risk of overloading of the semiconductor components of turn-off type of the auxiliary valve is registered, the commutation sequences controlled by the PWM-modulator are suitably interrupted in that the signal transmission from the modulator 30 to the above-mentioned first unit 24a of the control device 24 and/or from said first unit 24a to the above-mentioned second unit 24b of the control device 24 is blocked. In order to secure that all the current valves of the converter are returned to the safe state, i.e. to a state where there is no risk of overloading of the respective auxiliary valve, it is suitable to have the above-described protective measures effectuated in all the phase legs of the converter that are current carrying when an error situation is registered.

It is realised that the turn-off and turn-on, respectively, of the semiconductor elements of turn-off type of a current valve as described above and as indicated in the claims, refers to the simultaneous turn-off and turn-on, respectively, of all the semiconductor components 13a′, 13b′ of turn-off type of a current valve in those cases where the respective current valve comprises several series connected circuits 12 of previously indicated type. It is likewise realised that the turn-off and turn-on, respectively, of the semiconductor components of turn-off type of an auxiliary valve as described above and as indicated in the claims, in those cases where the auxiliary valve 18 comprises several series connected sets 22 of auxiliary valve circuits 19 of previously described type, refers to the simultaneous turn-off and turn-on, respectively, of all the semiconductor components 20a, 20b of turn-off type, to which voltage are applied or which are current carrying, of an auxiliary valve.

The invention is of course not in any way restricted to the preferred embodiments described above, on the contrary many possibilities to modifications thereof should be apparent to a person skilled in the art without departing from the basic idea of the invention as defined in the appended claims.

1. A converter comprising:
a series connection of at least two current valves (2, 3) arranged between two poles (4, 5), a positive and a negative, of a direct voltage side of the converter, each of which current valves comprising a semiconductor element (13a, 13b) of turn-off type and a rectifying member (14) connected in anti-parallel therewith, an alternating voltage phase line (11) being connected to a midpoint (10), denominated phase output, of the series connection between two current valves while dividing the series connection into two equal parts,
a series connection of at least two intermediate link capacitors (7, 8) arranged between the two poles (4, 5) of the direct voltage side of the converter,
a resonant circuit (16) comprising a series connection of an inductor (17) and an auxiliary valve (18) arranged between the phase output (10) and a midpoint (9) of said series connection of intermediate link capacitors (7, 8), which auxiliary valve (18) comprises at least one set (22) of two series connected auxiliary valve circuits (19), each of which comprising a semiconductor component (20a; 20b) of turn-off type and a rectifying component (21a; 21b) connected in anti-parallel therewith, the semiconductor components (20a, 20b) of turn-off type of the two auxiliary valve circuits being arranged in opposite polarity in relation to each other, the resonant circuit further comprising capacitive members (15), each of which being connected in series with said inductor (17) and auxiliary valve (18) and in parallel with one of said current valves (2, 3), and
a control device (24) for controlling the turn-on and turn-off of the semiconductor elements (13a, 13b) of turn-off type of the current valves and the semiconductor components (20a, 20b) of turn-off type of the auxiliary valve, characterized in that wherein the resonant circuit comprises means (31) for detecting a zero current condition in the auxiliary valve, which means (31) is adapted to send to the control device (24) signals indicating a prevailing zero current condition in the auxiliary valve, the control device (24) being adapted to admit a turn-off of a semiconductor component (20a, 20b) of turn-off type of the auxiliary valve only after the receipt by the control device (24) of a signal indicating a prevailing zero current condition in the auxiliary valve,
and that said means (31) for detecting a zero current condition in the auxiliary valve comprises one or several members (23) for detecting a blocking voltage of the rectifying components (21a, 21b) of the auxiliary valve.

2. A converter according to claim 1, wherein said one or several members (23) for detecting a blocking voltage of the rectifying components (21a, 21b) of the auxiliary valve consist of one or several control units (23) included in the auxiliary valve, which control units (23) are adapted to execute turn-on and turn-off of the semiconductor components (20a, 20b) of turn-off type of the auxiliary valve guided by control signals received from the control device (24).

3. A converter according to claim 1, wherein the control device (24) is adapted to effectuate a turn-off of a semiconductor component (20a, 20b) of turn-off type of the auxiliary valve with a time delay after the receipt by the control device (24) of a signal indicating a prevailing zero current condition in the auxiliary valve, the time delay being so chosen that the recombination process of the semiconductor component (20a, 20b) of turn-off type that is intended to be turned off will have time to be completed in the time interval from the moment a zero current condition is detected to the moment the semiconductor component (20a, 20b) is turned off.

4. A converter according to claim 1, wherein the auxiliary valve (18) comprises one or several control units (23) adapted to execute turn-on and turn-off of the semiconductor components (20a, 20b) of turn-off type guided by control signals received from the control device (24), and the respective current valve (2, 3) comprises one or several control units (25) adapted to execute turn-on and turn-off of the semiconductor elements (13a, 13b) of turn-off type of the current valve guided by control signals received from the control device (24), these control units (23, 25) being adapted to send to the control device (24) signals indicating whether a semiconductor component (20a, 20b) of turn-off type and a semiconductor element (13a, 13b) of turn-off type, respectively, is in turned-off or turned-on state.

5. A converter according to claim 4, wherein the control device (24) is adapted to admit a turn-on of a semiconductor component (20a, 20b) of turn-off type of the auxiliary valve only if it has received from the control unit (25) belonging to a semiconductor element (13a, 13b) of turn-off type of a current valve with the same polarity a signal indicating that this semiconductor element (13a, 13b) of turn-off type is in turned-off state.

6. A converter according to claim 4, wherein the control device (24) is adapted to admit a turn-on of a semiconductor element (13a, 13b) of turn-off type of a current valve (2, 3) only if it has received from a control unit (23) belonging to a semiconductor component (20a, 20b) of turn-off type of an auxiliary valve with the same polarity a signal indicating that this semiconductor component (20a, 20b) of turn-off type is in turned-off state.

7. A converter according to claim 4, wherein the control device (24) is adapted to admit a turn-on of a semiconductor component (20a, 20b) of turn-off type of the auxiliary valve only if it has received from the control unit(-s) (23) of the auxiliary valve a signal indicating that the semiconductor components (20b, 20a) of turn-off type with opposite polarity of the auxiliary valve is in turned-off state.

8. A converter according to claim 4, wherein the control device (24) is adapted to allow a turn-off of a semiconductor element (13a, 13b) of turn-off type of a current valve only if it has received from the control unit (23) belonging to a semiconductor (20b, 20a) of turn-off type with opposite polarity of the auxiliary valve a signal indicating that this semiconductor component (20b, 20a) of turn-off type is in turned-off state.

9. A converter according to claim 1, wherein the control device (24), in connection with the effectuation of a turn-on of a semiconductor component (20a, 20b) of turn-off type of the auxiliary valve (18), is adapted to send a turn-on signal of time-delayed type to a control unit (25) that is arranged to execute turn-on and turnoff of a semiconductor element (13b, 13a) of turn-off type with opposite polarity, this control unit (25) being adapted to turn on the semiconductor element (13a, 13b) of turn-off type after a predetermined time length has elapsed from the moment the control unit (25) received said turn-on signal unless the control unit (25) receives a turn-on signal of ordinary type from the control device (24) before said predetermined time length has elapsed.

10. A converter according to claim 1, wherein the auxiliary valve (18) comprises several series connected sets (22) of auxiliary valve circuits, where each set comprises two series connected auxiliary valve circuits (19), each of which comprising a semiconductor component (20a; 20b) of turn-off type and a rectifying component (21a; 21b) connected in anti-parallel therewith, the semiconductor components (20a, 20b) of turn-off type of the two auxiliary valve circuits in one and the same set being arranged in opposite polarity in relation to each other.

11. A converter according to claim 1, wherein the semiconductor components (20a, 20b) of turn-off type of the auxiliary valve are designed for a maximum allowed turn-off current essentially corresponding to zero current.

12. A method for controlling a converter, which converter comprises:
a series connection of at least two current valves (2, 3) arranged between two poles (4, 5), a positive and a negative, of a direct voltage side of the converter, each of which current valves comprising a semiconductor element (13a, 13b) of turn-off type and a rectifying member (14) connected in anti-parallel therewith, an alternating voltage phase line (11) being connected to a midpoint (10), denominated phase output, of the series connection between two current valves while dividing the series connection into two equal parts,
a series connection of at least two intermediate link capacitors (7, 8) arranged between the two poles (4, 5) of the direct voltage side of the converter,
a resonant circuit (16) comprising a series connection of an inductor (17) and an auxiliary valve (18) arranged between the phase output (10) and a midpoint (9) of said series connection of intermediate link capacitors (7, 8),
which auxiliary valve (18) comprises at least one set (22) of two series connected auxiliary valve circuits (19), each of which comprising a semiconductor component (20a; 20b) of turn-off type and a rectifying component (21a; 21b) connected in anti-parallel therewith, the semiconductor components (20a, 20b) of turn-off type of the two auxiliary valve circuits being arranged in opposite polarity in relation to each other, the resonant circuit further comprising capacitive members (15), each of which being connected in series with said inductor (17) and auxiliary valve (18) and in parallel with one of said current valves (2, 3), and
a control device (24) for controlling the turn-on and turn-off of the semiconductor elements (13a, 13b) of turn-off type of the current valves and the semiconductor components (20a, 20b) of turn-off type of the auxiliary valve,
wherein a zero current condition in the auxiliary valve (18) is detected with the aid of a means (31) included in the resonant circuit, this means (31) being made to send to the control device (24) signals indicating a prevailing zero current condition in the auxiliary valve,
that the control device (24) is made to allow a turn-off of a semiconductor component (20a, 20b) of turn-off type of the auxiliary valve only after the receipt by the control device (24) of a signal indicating a prevailing zero current condition in the auxiliary valve, and
that a zero current condition in the auxiliary valve (18) is detected with the aid of one or several members (23) included in said means (31), which members detect a blocking voltage of the rectifying components (21a, 21b) of the auxiliary valve.

13. A method according to claim 12, wherein a blocking voltage of the rectifying components (21a, 21b) of the auxiliary valve is detected with the aid of one or several control units (23) included in the auxiliary valve, which control units (23) are adapted to execute turn-on and turn-off of the semiconductor components (20a, 20b) of turn-off type of the auxiliary valve guided by control signals received from the control device (24).

14. A method according to claim 12, wherein the control device (24) is made to effectuate a turn-off of a semiconductor component (20a, 20b) of turn-off type of the auxiliary valve with a time delay after the receipt by the control device (24) of a signal indicating a prevailing zero current condition in the auxiliary valve, the time delay being so chosen that the recombination process of the semiconductor component (20a, 20b) of turn-off type that is intended to be turned off will have time to be completed in the time interval from the moment a zero current condition is detected to the moment the semiconductor component (20a, 20b) is turned off.

15. A method according to claim 12, wherein turn-on and turn-off of the semiconductor components (20a, 20b) of turn-off type of the auxiliary valve (18) is executed with the aid one or several first control units (23) guided by control signals received from the control device (24), and that turn-on and turn-off of the semiconductor element (13a, 13b) of turn-off type of the respective current valve (2, 3) is executed with the aid of one or several second control units (25) guided by control signals received from the control device (24), these first and second control units (23, 25) sending to the control device (24) signals indicating whether a semiconductor component (20a, 20b) of turn-off type and a semiconductor element (13a, 13b) of turn-off type, respectively, is in turned-off or turned-on state.

16. A method according to claim 15, wherein the control device (24) is made to allow a turn-on of a semiconductor component (20a, 20b) of turn-off type of the auxiliary valve only if it has received from the control unit (25) belonging to a semiconductor element (13a, 13b) of turn-off type of a current valve with the same polarity a signal indicating that this semiconductor element (13a, 13b) of turn-off type is in turned-off state.

17. A method according to claim 15, wherein the control device (24) is made to allow a turn-on of a semiconductor element (13a, 13b) of turn-off type of a current valve (2, 3) only if it has received from the control unit (23) belonging to a semiconductor component (20a, 20b) of turn-off type with the same polarity of the auxiliary valve a signal indicating that this semiconductor component (20a, 20b) of turn-off type is in turned-off state.

18. A method according to claim 15, wherein the control device (24) is made to allow a turn-on of a semiconductor component (20a, 20b) of turn-off type of the auxiliary valve only if it has received from the control unit(-s) (23) of the auxiliary valve a signal indicating that the semiconductor components (20b, 20a) of turn-off type with opposite polarity of the auxiliary valve is in turned-off state.

19. A method according to claim 15, wherein the control device (24) is made to allow a turn-off of a semiconductor element (13a, 13b) of turn-off type of a current valve only if it has received from a control unit (23) belonging to a semiconductor component (20b, 20a) of turn-off type with opposite polarity of the auxiliary valve a signal indicating that this semiconductor component (20b, 20a) of turn-off type is in turned-off state.

20. A method according to claim 12, wherein the control device (24) in connection with the effectuation of a turn-on of a semiconductor component (20a, 20b) of turn-off type of the auxiliary valve (18) is made to send a turn-on signal of time-delayed type to a control unit (25) that is arranged to execute turn-on and turn-off of a semiconductor element (13b, 13a) of turn-off type with opposite polarity of a current valve, this control unit (25) being made to turn on the semiconductor element (13b, 13a) of turn-off type after a predetermined time length has elapsed from the moment the control unit (25) received said turn-on signal unless the control unit (25) receives a turn-on signal of ordinary type from the control device (24) before the predetermined time length has elapsed.

21. A method according to claim 20, wherein the following steps are carried out in case the auxiliary valve (18) is still current carrying after a predetermined time length, which is longer than the time delay of said turn-on signal of time-delayed type, has elapsed from the moment said turn-on signal of time-delayed type was sent from the control device (24):
a turn-off signal is sent from the control device (24) to the current valve (2, 3) that is presently feeding current to the auxiliary valve (18),
when the control device (24) has received a turn-off confirmation from the current valve (2, 3) to which the turn-off signal was sent, a turn-on signal is sent to the opposite current valve (3, 2), preferably only on condition that at least one of the current valves (2, 3) is in the blocking state and that the control device (24) has received a turn-off confirmation from both current valves,
when a blocking voltage has been detected of the rectifying component or components (21a, 21b) of the auxiliary valve that was/were current carrying when it was registered that the auxiliary valve (18) was still current carrying, or when it has been established that the strength of the current has decreased below the SSOA-level (SSOA=Switching Safe Operating Area) for the semiconductor components (20a, 20b) of turn-off type of the auxiliary valve, a turn-off signal is sent from the control device (24) to the auxiliary valve (18), and
when the control device (24) has received a turn-off confirmation from the auxiliary valve (18), a turn-off signal is finally sent from the control device (24) to both current valves (2, 3).

22. A method according to claim 12, wherein the strength of the current through the resonant circuit is measured and compared with a predetermined maximum allowed value, and that the following steps are carried out in case the comparison shows that the current has a strength exceeding the maximum allowed value when the auxiliary valve (18) and one current valve (2, 3) are simultaneously conducting a current:
a turn-off signal is sent from the control device (24) to the current valve (2, 3) that is presently feeding current to the auxiliary valve (18),
when the control device (24) has received a turn-off confirmation from the current valve (2, 3) to which the turn-off signal was sent, a turn-on signal is sent to the opposite current valve (3, 2), preferably only on condition that at least one of the current valves (2, 3) is in the blocking state and that the control device (24) has received a turn-off confirmation from both current valves,
when a blocking voltage has been detected of the rectifying component or components (21a, 21b) of the auxiliary valve that was/were current carrying when it was registered that the current strength exceeded the maximum allowed value, or when it is established that the strength of the current has decreased below the SSOA-level (SSOA=Switching Safe Operating Area) for the semiconductor components (20a, 20b) of turn-off type of the auxiliary valve, a turn-off signal is sent from the control device (24) to the auxiliary valve (18), and
when the control device (24) has received a turn-off confirmation from the auxiliary valve (18), a turn-off signal is finally sent from the control device (24) to both current valves (2, 3).

23. A converter according to claim 2, wherein the control device (24) is adapted to effectuate a turn-off of a semiconductor component (20a, 20b) of turn-off type of the auxiliary valve with a time delay after the receipt by the control device (24) of a signal indicating a prevailing zero current condition in the auxiliary valve, the time delay being so chosen that the recombination process of the semiconductor component (20a, 20b) of turn-off type that is intended to be turned off will have time to be completed in the time interval from the moment a zero current condition is detected to the moment the semiconductor component (20a, 20b) is turned off.

24. A converter according to claim 5, wherein the control device (24) is adapted to admit a turn-on of a semiconductor element (13a, 13b) of turn-off type of a current valve (2, 3) only if it has received from a control unit (23) belonging to a semiconductor component (20a, 20b) of turn-off type of an auxiliary valve with the same polarity a signal indicating that this semiconductor component (20a, 20b) of turn-off type is in turned-off state.

25. A converter according to claim 5, wherein the control device (24) is adapted to admit a turn-on of a semiconductor component (20a, 20b) of turn-off type of the auxiliary valve only if it has received from the control unit(-s) (23) of the auxiliary valve a signal indicating that the semiconductor components (20b, 20a) of turn-off type with opposite polarity of the auxiliary valve is in turned-off state.

26. A converter according claim 6, wherein the control device (24) is adapted to admit a turn-on of a semiconductor component (20a, 20b) of turn-off type of the auxiliary valve only if it has received from the control unit(-s) (23) of the auxiliary valve a signal indicating that the semiconductor components (20b, 20a) of turn-off type with opposite polarity of the auxiliary valve is in turned-off state.

27. A method according to claim 13, wherein turn-on and turn-off of the semiconductor components (20a, 20b) of turn-off type of the auxiliary valve (18) is executed with the aid one or several first control units (23) guided by control signals received from the control device (24), and that turn-on and turn-off of the semiconductor element (13a, 13b) of turn-off type of the respective current valve (2, 3) is executed with the aid of one or several second control units (25) guided by control signals received from the control device (24), these first and second control units (23, 25) sending to the control device (24) signals indicating whether a semiconductor component (20a, 20b) of turn-off type and a semiconductor element (13a, 13b) of turn-off type, respectively, is in turned-off or turned-on state.

28. A method according to claim 14, wherein turn-on and turn-off of the semiconductor components (20a, 20b) of turn-off type of the auxiliary valve (18) is executed with the aid one or several first control units (23) guided by control signals received from the control device (24), and that turn-on and turn-off of the semiconductor element (13a, 13b) of turn-off type of the respective current valve (2, 3) is executed with the aid of one or several second control units (25) guided by control signals received from the control device (24), these first and second control units (23, 25) sending to the control device (24) signals indicating whether a semiconductor component (20a, 20b) of turn-off type and a semiconductor element (13a, 13b) of turn-off type, respectively, is in turned-off or turned-on state.

29. A method according to claim 16, wherein the control device (24) is made to allow a turn-on of a semiconductor element (13a, 13b) of turn-off type of a current valve (2, 3) only if it has received from the control unit (23) belonging to a semiconductor component (20a, 20b) of turn-off type with the same polarity of the auxiliary valve a signal indicating that this semiconductor component (20a, 20b) of turn-off type is in turned-off state.

30. A method according to claim 16, wherein the control device (24) is made to allow a turn-on of a semiconductor component (20a, 20b) of turn-off type of the auxiliary valve only if it has received from the control unit(-s) (23) of the auxiliary valve a signal indicating that the semiconductor components (20b, 20a) of turn-off type with opposite polarity of the auxiliary valve is in turned-off state.

31. A method according to claim 17, wherein the control device (24) is made to allow a turn-on of a semiconductor component (20a, 20b) of turn-off type of the auxiliary valve only if it has received from the control unit(-s) (23) of the auxiliary valve a signal indicating that the semiconductor components (20b, 20a) of turn-off type with opposite polarity of the auxiliary valve is in turned-off state.

32. A method according to claim 16, wherein the control device (24) is made to allow a turn-off of a semiconductor element (13a, 13b) of turn-off type of a current valve only if it has received from a control unit (23) belonging to a semiconductor component (20b, 20a) of turn-off type with opposite polarity of the auxiliary valve a signal indicating that this semiconductor component (20b, 20a) of turn-off type is in turned-off state.

33. A method according to claim 17, wherein the control device (24) is made to allow a turn-off of a semiconductor element (13a, 13b) of turn-off type of a current valve only if it has received from a control unit (23) belonging to a semiconductor component (20b, 20a) of turn-off type with opposite polarity of the auxiliary valve a signal indicating that this semiconductor component (20b, 20a) of turn-off type is in turned-off state.

34. A method according to claim 18, wherein the control device (24) is made to allow a turn-off of a semiconductor element (13a, 13b) of turn-off type of a current valve only if it has received from a control unit (23) belonging to a semiconductor component (20b, 20a) of turn-off type with opposite polarity of the auxiliary valve a signal indicating that this semiconductor component (20b, 20a) of turn-off type is in turned-off state.
